(19) United States
(12) Patent Application Publication
(10) Pub. No.: US 2026/0075602 A1
(43) Pub. Date: Mar. 12, 2026

(54) METHOD AND SYSTEM FOR MANAGING DEDICATED CONFIGURED GRANT (CG) RESOURCES FOR SMALL DATA TRANSMISSION

(71) Applicant: Samsung Electronics Co., Ltd., Suwon-si (KR)

(72) Inventors: Amit MITTAL, Noida (IN); Shivangi TANEJA, Noida (IN); Shivank GARG, Noida (IN)

(21) Appl. No.: 19/207,192

(22) Filed: May 13, 2025

Related U.S. Application Data
(63) Continuation of application No. PCT/KR2025/005587, filed on Apr. 24, 2025.

(30) Foreign Application Priority Data
Sep. 9, 2024 (IN) 202411067982

(51) Int. Cl. H04W 72/115; H04B 17/309; H04B 17/318

(52) U.S. Cl. CPC H04W 72/115; H04B 17/318; H04B 17/346

(57) ABSTRACT

The present disclosure relates to method for managing a set of dedicated configured grant (CG) resources for small data transmission in a primary device. The method comprises: estimating an availability of one or more dedicated CG resources in the primary device; receiving one or more signal strength indicator (RSSI) values of one or more secondary devices related to the primary; detecting one or more trusted devices from the one or more secondary devices based on the one or more RSSI values; selecting at least one target trusted device from the one or more trusted devices and transmitting a CG resource release message to the target trusted device; and transmitting a small data related to the primary device on one or more available CG resources of the target trusted device.

### CROSS-REFERENCE TO RELATED APPLICATIONS

This application is a continuation of International Application No. PCT/KR2025/005587 designating the United States, filed on Apr. 24, 2025, in the Korean Intellectual Property Receiving Office and claiming priority to Indian Complete patent application No. 202411067982, filed on Sep. 9, 2024, in the Indian Patent Office, the disclosures of each of which are incorporated by reference herein in their entireties.

### BACKGROUND

### Field

The disclosure relates to a field of wireless communications technology. For example, the disclosure relates to a method and system for managing a set of dedicated configured grant (CG) resources for small data transmission in a primary device.

### Description of Related Art

The following description of the related art is intended to provide background information pertaining to the field of the disclosure. This section may include certain aspects of the art that may be related to various features of the present disclosure. However, it should be appreciated that this section is used simply to enhance the understanding of the reader with respect to the present disclosure, and not as admissions of the prior art.

Radio Resource Control (RRC) is a layer 3 protocol that facilitates communication between a user equipment (UE) and a network. The RRC manages one or more connection states between the UE and the network. The connection state may be one of a RRC connected state, a RRC idle state and a RRC inactive state. The UE needs to establish a connection with the network to perform data transfer and/or make/receive calls. Once the connection between the UE and the network is established, the UE is in the RRC connected state. Further, if there is no activity from the UE, such as if the UE is not actively communicating with the network, the UE moves into the RRC idle state. Whenever the UE needs to communicate with the network, the UE needs to transition from the RRC idle state to the RRC connected state. Further, the UE needs to perform the procedure to establish the connection with the network, thereby resulting in increased latency and increased signalling load on the network. Further, the UE keeps sending small amounts of data very frequently, leading to regular transitions from the RRC ideal state to the RRC connected state and back to the RRC ideal state. The frequent transition between the RRC ideal state and the RRC connected state further increases the signalling load on the network and also increases the latency. Therefore, the RRC inactive state was introduced to reduce the signalling load on the network and the latency involved in transitioning to the RRC connected state.

Further, in the RRC inactive state, the UE may transmit a small amount of data while remaining inactive, e.g., without establishing connection with the network and transitioning into the RRC connected state. The small amount of data may be transmitted using a Small Data Transmission (SDT) procedure. The SDT allows the UE to quickly transmit the data on the allocated resources. Further, the SDT is enabled on a radio bearer basis and is initiated by the UE only if less than a configured amount of UL data awaits transmission across all radio bearers for which the SDT is enabled. Furthermore, the SDT may be performed by way of preconfigured radio resources or configured grant (CG-SDT). In the CG-SDT, the radio resources are preconfigured and are allocated periodically based on the estimation of the UE's traffic requirements.

Currently, as per the existing solution in the CG, time-frequency resources are assigned periodically, where the device transmits on these pre-assigned resources. Thus, the aperiodic arrival of uplink data at the UE leads to an increase in the latency in data transmission as uplink (UL) data has to wait for the CG occasion due to CG periodicity. Further, due to periodically assigned resources and aperiodic traffic, resources are also inefficiently utilized and wasted. Further, as the existing solution suggests, the uplink data transmission in a configured grant small data transfer (CG-SDT) occasion in the CG-SDT occasion group is associated with multiple UEs.

Thus, there exists a need in the art to address the above-mentioned and such other technical limitations of the existing solutions. Hence, there is a need in the art of a method and a system for managing a set of dedicated configured grant (CG) resources for small data transmission.

### SUMMARY

According to an example embodiment, the present disclosure may relate to a method for managing a set of dedicated configured grant (CG) resources for small data transmission in a primary device. The method comprises: estimating an availability of one or more dedicated CG resources in the primary device; receiving one or more signal strength indicator (RSSI) values of one or more secondary devices related to the primary device; detecting one or more trusted devices from the one or more secondary devices based on the one or more RSSI values; selecting at least one target trusted device from the one or more trusted devices and transmitting a CG resource release message to the target trusted device; and transmitting a small data related to the primary device on one or more available CG resources of the target trusted device.

According to an example embodiment of the present disclosure, the method comprises reserving the one or more available CG resources of the target trusted device based on the CG resource release message.

According to an example embodiment of the present disclosure, the availability of the one or more dedicated CG resources in the primary device is estimated based on an uplink data transmission periodicity parameter of the one or more dedicated CG resources in the primary device.

According to an example embodiment of the present disclosure, to detect the one or more trusted devices from the one or more secondary devices, the method comprises: comparing the one or more RSSI values with a predefined (e.g., specified) threshold RSSI value, wherein the predefined threshold RSSI value is related to an event when the primary device and the one or more trusted devices are in a range of a wireless network, and comparing an identifier of the primary device with one or more identifiers of the one or more secondary devices.

According to an example embodiment of the present disclosure, the one or more secondary devices are detected as the one or more trusted devices in an event the one or more RSSI values is above the predefined threshold RSSI value, and a value of the one or more identifiers of the one or more secondary devices matches to a value of the identifier of the primary device.

According to an example embodiment of the present disclosure, the target trusted device from the one or more trusted devices is selected based on at least one of an availability of one or more CG resources of the one or more trusted devices, an uplink data transmission periodicity of the one or more CG resources, a signal to noise (SNR) ratio of the one or more trusted devices, a signal power of the one or more trusted devices, and a transmission probability of another small data at set of the trusted device CG resources.

According to an example embodiment of the present disclosure, the method further comprises determining a data transmission probability of the small data on the one or more CG resources based on at least one of the availability of the one or more CG resources, the SNR ratio, the uplink data transmission periodicity, and the signal power.

According to an example embodiment of the present disclosure, the one or more available CG resources of the target trusted device are further reserved based on the data transmission probability of the small data.

According to an example embodiment of the present disclosure, the reserving the one or more available CG resources of the target trusted device further comprises exchanging the one or more available CG resources with at least the one or more dedicated CG resources in the primary device.

According to an example embodiment of the present disclosure, the method comprises determining a suitability of the small data for an uplink transmission based on a comparison of a volume parameter of the small data for the uplink transmission with a predefined volume parameter threshold for the uplink transmission.

According to an example embodiment of the present disclosure a system for managing a set of dedicated configured grant (CG) resources for small data transmission in a primary device is provided. The system comprises: a memory unit comprising a memory, and at least one processor, comprising processing circuitry, connected at least to the memory unit, wherein at least one processor, individually and/or collectively, is configured to cause the system to: estimate an availability of one or more dedicated CG resources in the primary device; receive one or more signal strength indicator (RSSI) values of one or more secondary devices related to the primary device; detect one or more trusted devices from the one or more secondary devices based on the one or more RSSI values; select at least one target trusted device from the one or more trusted devices and transmitting a CG resource release message to the target trusted device; and transmit a small data related to the primary device on one or more available CG resources of the target trusted device.

According to an example embodiment of the present disclosure a non-transitory computer readable storage medium storing instructions for managing a set of dedicated configured grant (CG) resources for small data transmission in a primary device, is provided, wherein the instructions include executable code which, when executed by a at least one processor, comprising processing circuitry, individually and/or collectively, of a system, causes the system to: estimate an availability of one or more dedicated CG resources in the primary device; receive one or more signal strength indicator (RSSI) values of one or more secondary devices related to the primary device; detect one or more trusted devices from the one or more secondary devices based on the one or more RSSI values; select at least one target trusted device from the one or more trusted devices and transmitting a CG resource release message to the target trusted device; and transmit a small data related to the primary device on one or more available CG resources of the target trusted device.

Embodiments of the disclosure provide a method and system for managing a set of dedicated configured grant (CG) resources for small data transmission.

Embodiments of the present disclosure manage dedicated configured grant resources for short data transmission in a device efficiently.

Embodiments of the present disclosure estimate the availability of dedicated configured grant resources based on CG periodicity for transmitting uplink data.

Embodiments of the present disclosure detect trusted devices nearby to the device based on received signal strength indicator (RSSI).

Embodiments of the present disclosure select at least one trusted device with an optimum dedicated CG resource based on a signal power, an uplink data transmission periodicity of configured grant (CG) resources, and a signal-to-noise ratio.

Embodiments of the present disclosure reserve configured grant (CG) resources for transmitting uplink data of the trusted device reliably and efficiently.

Embodiments of the present disclosure optimize and/or improve the use of dedicated configured grant resources for short data transmission.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of a system for managing a set of dedicated configured grant (CG) resources for small data transmission in a primary device, according to various embodiments;

FIG. 2 is a block diagram illustrating an example configuration of a system for managing a set of dedicated configured grant (CG) resources for small data transmission in a primary device, according to various embodiments;

FIG. 3 is a flowchart illustrating an example process for managing a set of dedicated configured grant (CG) resources for small data transmission in a primary device, according to various embodiments;

FIG. 4 is a diagram illustrating an example arrangement of devices, according to various embodiments; and

FIG. 5 is a timing diagram illustrating an example of small data transmission over dedicated configured grant (CG) resources between one or more devices, according to various embodiments.

The foregoing shall be more apparent from the following more detailed description of the disclosure.

### DETAILED DESCRIPTION

The accompanying drawings, which are incorporated herein, and are a part of this disclosure, illustrate various example embodiments of the disclosed methods and systems in which like reference numerals refer to the same parts throughout the different drawings. Components in the drawings are not necessarily to scale, emphasis instead being placed upon clearly illustrating the principles of the present disclosure. Various example embodiments shown in the figures are not to be construed as limiting the disclosure, but the possible variants of the method and system according to the disclosure are illustrated herein to highlight the advantages of the disclosure. It will be appreciated by those skilled in the art that disclosure of such drawings includes disclosure of electrical components or circuitry commonly used to implement such components.

The terms and words used in the following description and claims are not be limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces. In various examples of the disclosure described below, a hardware approach will be described as an example. However, since various embodiments of the disclosure may include a technology that utilizes both the hardware-based and the software-based approaches, they are not intended to exclude the software-based approach.

As used herein, the terms referring to merging (e.g., merging, grouping, combination, aggregation, joint, integration, unifying), the terms referring to signals (e.g., packet, message, signal, information, signaling), the terms referring to resources (e.g. section, symbol, slot, subframe, radio frame, subcarrier, resource element (RE), resource block (RB), bandwidth part (BWP), opportunity), the terms used to refer to any operation state (e.g., step, operation, procedure), the terms referring to data (e.g. packet, message, user stream, information, bit, symbol, codeword), the terms referring to a channel, the terms referring to a network entity (e.g., distributed unit (DU), radio unit (RU), central unit (CU), control plane (CU-CP), user plane (CU-UP), O-DU-open radio access network (O-RAN) DU), O-RU (O-RAN RU), O-CU (O-RAN CU), O-CU-UP (O-RAN CU-CP), O-CU-CP (O-RAN CU-CP)), the terms referring to the components of an apparatus or device, or the like are only illustrated for convenience of description in the disclosure. Therefore, the disclosure is not limited to those terms described below, and other terms having the same or equivalent technical meaning may be used therefore. Further, as used herein, the terms, such as ‘˜ module’, ‘˜ unit’, ‘˜ part’, ‘˜ body’, or the like may refer to at least one shape of structure or a unit for processing a certain function.

Further, throughout the disclosure, an expression, such as e.g., ‘above’ or ‘below’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with an expression, such as ‘above’, a condition described as ‘less than or equal to’ may be replaced with an expression, such as ‘below’, and a condition described as ‘more than or equal to and below’ may be replaced with ‘above and less than or equal to’, respectively. Furthermore, hereinafter, ‘A’ to ‘B’ means at least one of the elements from A (including A) to B (including B). Hereinafter, ‘C’ and/or ‘D’ means including at least one of ‘C’ or ‘D’, that is, {′C′, ‘D’, or ‘C’ and ‘D’}.

The disclosure describes various embodiments using terms used in some communication standards (e.g., 3rd Generation Partnership Project (3GPP), extensible radio access network (xRAN), open-radio access network (O-RAN) or the like), but it is only of an example for explanation, and the various embodiments of the disclosure may be easily modified even in other communication systems and applied thereto.

In the following description, for the purposes of explanation, various details are set forth in order to provide a thorough understanding of various example embodiments of the present disclosure. It will be apparent, however, that the various embodiments of the present disclosure may be practiced without these specific details. Several features described hereafter may each be used independently of one another or with any combination of other features. An individual feature may not address any of the problems disclosed above or might address only some of the problems disclosed above.

The ensuing description provides various example embodiments, and is not intended to limit the scope, applicability, or configuration of the disclosure. Rather, the ensuing description of the example embodiments will provide those skilled in the art with an enabling description. It should be understood that various changes may be made in the function and arrangement of elements without departing from the spirit and scope of the disclosure as set forth.

Specific details are given in the following description to provide a thorough understanding of the various example embodiments. However, it will be understood by one of ordinary skill in the art that the example embodiments may be practiced without these specific details. For example, circuits, systems, processes, and other components may be shown as components in block diagram form in order not to obscure the example embodiments in unnecessary detail.

It should be noted that the terms “first”, “second”, “primary”, “secondary”, “target” and the like, herein do not denote any order, ranking, quantity, or importance, but rather are used to distinguish one element from another.

It is noted that various embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included or illustrated in the figure.

The word “exemplary” and/or “demonstrative” is used herein to refer to serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent example structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

As used herein, a “processing unit” or “processor” or “at least one processor” or “operating processor” includes one or more processors, and may be used interchangeably herein, wherein processor refers to any logic circuitry for processing instructions. A processor may be a general-purpose processor, a special purpose processor, a conventional processor, a digital signal processor, a plurality of microprocessors, one or more microprocessors in association with a Digital Signal Processing (DSP) core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. For example, the processor or processing unit [104] is a hardware processor. In view of the foregoing, it will be understood that the processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from unit(s) which are required to implement the features of the present disclosure.

All modules, units, components used herein, unless explicitly excluded herein, may be software modules or hardware processors, the processors being a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASIC), Field Programmable Gate Array circuits (FPGA), any other type of integrated circuits, etc.

One or more of the plurality of modules may be implemented through an AI model. A function associated with AI may be performed through the non-volatile memory, the volatile memory, and the processor. The processor may include one or a plurality of processors. For implementing the one or the plurality of modules through an AI model, the one or the plurality of processors may be a general purpose processor(s), such as a central processing unit (CPU), an application processor (AP), or the like, a graphics-only processing unit such as a graphics processing unit (GPU), a visual processing unit (VPU), and/or an AI-dedicated processor such as an image processor. The one or the plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning refer, for example, to, by applying a learning algorithm(s) to a plurality of learning data, a predefined operating rule or AI model of a desired characteristic being made. The learning may be performed in a device itself in which AI according to an embodiment is performed, and/or may be implemented through a separate server/system. The AI model may include a plurality of neural network layers, such as long short-term memory (LSTM) layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

A learning algorithm may refer, for example, to a method for training a device (for example, a robot) using a plurality of learning data to cause, allow, or control the device to make a determination or prediction. Examples of learning algorithms include, but are not limited to, supervised learning, unsupervised learning, semi-supervised learning, or reinforcement learning.

As disclosed in the background section above, the current known solutions have several shortcomings. The present disclosure aims to address the above-mentioned and other existing problems in this field of technology by providing a novel disclosure for managing a set of dedicated configured grant (CG) resources for small data transmission in a primary device. Further, the present disclosure, intelligently selects trusted devices based on key parameters such as a signal power, a configured grant (CG) periodicity, and a signal-to-noise ratio (SNR) to optimize the utilization of dedicated CG resources for small data transmissions in a device. The disclosure estimates the availability of dedicated CG resources by checking their periodicity for uplink data transmission. It then detects nearby trusted devices based on the received signal strength indicator (RSSI). The trusted devices group is configured on the user equipment (UE) side using RSSI measurements. The present disclosure selects the most suitable trusted device with the optimum dedicated CG resource. This selection is based on a combination of signal power, CG periodicity, and SNR. By leveraging an AI model, the disclosure intelligently analyses these parameters to choose the trusted device that can provide the best CG resource for the uplink data transmission. Further, once the optimal trusted device is selected, the disclosure reserves the chosen CG resource and transmits the uplink data using the reserved resource of the trusted device. Therefore, the present disclosure ensures efficient utilization of dedicated CG resources and enhances the overall performance of small data transmissions in the device.

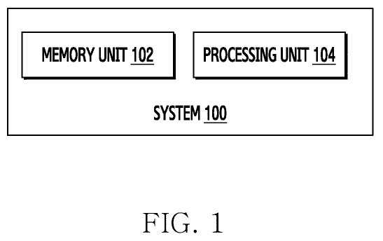

FIG. 1, is a block diagram illustrating an example configuration of a system [100] for managing a set of dedicated configured grant (CG) resources for small data transmission in a primary device, according to various embodiments. The system [100] comprises at least one processing unit (e.g., including at least one processor including processing circuitry) [104], and at least one memory unit (e.g., including a memory) [102]. The components/units of the system [100] are assumed to be connected to each other unless otherwise indicated below. In FIG. 1 various example units are shown, however, the system [100] may comprise multiple such units, or the system [100] may comprise any such number of said units, as required to implement the features of the present disclosure. In an implementation, the system [100] may reside in and/or connected to and/or in communication with a user device (may also be referred herein as a user equipment or a UE) to implement the features of the present disclosure. In an implementation, the system [100] may reside in a server. The term “processing unit” as used herein may include various processing circuitry, individually and/or collectively configured to perform the various functions. The processor or processing unit [104] is described in greater detail above and the description is incorporated here.

To manage a set of dedicated configured grant (CG) resources for small data transmission in a primary device, the processing unit [104] is configured to estimate an availability of one or more dedicated CG resources in the primary device. The availability of the one or more dedicated CG resources in the primary device is estimated based on an uplink data transmission periodicity parameter of the one or more dedicated CG resources in the primary device.

The processing unit [104] is configured to receive one or more signal strength indicator (RSSI) values of one or more secondary devices related to the primary device.

The processing unit [104] is configured to detect one or more trusted devices from the one or more secondary devices based on the one or more RSSI values. In an implementation of the present disclosure, to detect the one or more trusted devices from the one or more secondary devices, the processing unit [104] is configured to compare the one or more RSSI values with a predefined (e.g., specified) threshold RSSI value, wherein the predefined threshold RSSI value is related to an event when the primary device and the one or more trusted devices are in a range of a wireless network. In an implementation of the present disclosure, to detect the one or more trusted devices from the one or more secondary devices, the processing unit [104] is configured to compare an identifier of the primary device with one or more identifiers of the one or more secondary devices.

In an implementation of the present disclosure, the one or more secondary devices are detected as the one or more trusted devices in an event the one or more RSSI values is above the predefined threshold RSSI value. In an implementation of the present disclosure, the one or more secondary devices are detected as the one or more trusted devices in an event a value of the one or more identifiers of the one or more secondary devices matches to a value of the identifier of the primary device.

The processing unit [104] is configured to select at least one target trusted device from the one or more trusted devices and transmit a CG resource release message to the target trusted device. The target trusted device from the one or more trusted devices is selected by the processing unit [104] based on at least one of an availability of one or more CG resources of the one or more trusted devices, an uplink data transmission periodicity of the one or more CG resources, a signal to noise (SNR) ratio of the one or more trusted devices, a signal power of the one or more trusted devices, and a transmission probability of another small data at set of the trusted device CG resources.

In an implementation of the present disclosure, the processing unit [104] is configured to determine a data transmission probability of the small data on the one or more CG resources based on at least one of the availability of the one or more CG resources, the SNR ratio, the uplink data transmission periodicity, and the signal power.

The processing unit [104] is configured to transmit a small data related to the primary device on one or more available CG resources of the target trusted device. Further, the one or more available CG resources of the target trusted device are further reserved based on the data transmission probability of the small data.

In an implementation of the present disclosure, the processing unit [104] is configured to reserve the one or more available CG resources of the target trusted device based on the CG resource release message. Further, in an implementation, to reserve the one or more available CG resources of the target trusted device the processing unit [104] is configured to exchange the one or more available CG resources with at least the one or more dedicated CG resources in the primary device.

In an implementation of the present disclosure, the processing unit [104] is configured to determine a suitability of the small data for an uplink transmission based on a comparison of a volume parameter of the small data for the uplink transmission with a predefined volume parameter threshold for the uplink transmission.

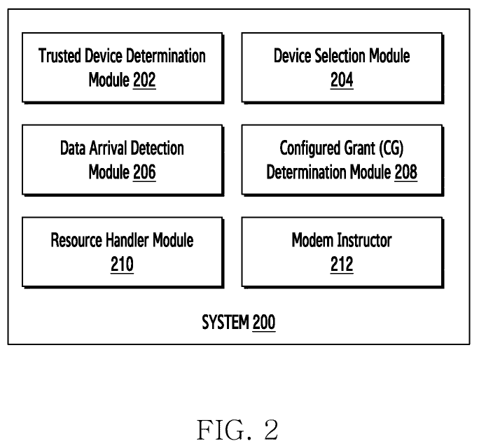

FIG. 2, is a block diagram illustrating an example configuration of a system [200] for managing a set of dedicated configured grant (CG) resources for small data transmission in a primary device, according to various embodiments. The system [200], in an implementation, comprises the various example modules to implement one or more features of the present disclosure. These example modules as shown in FIG. 2, in an implementation, may be implemented by the processing unit [104] of the system [100], and may include various circuitry and/or executable program instructions.

As shown in FIG. 2, the system [200] comprises at least one trusted device determination module [202], at least one device selection module [204], at least one data arrival detection module [206], at least one configured grant (CG) determination module [208], at least one resource handler module [210], and at least one modem instructor [212]. Each of these modules may include various circuitry and/or executable program instructions and may be explained in greater detail with reference to one or more figures in the following description. Further, for managing the set of dedicated configured grant (CG) resources for small data transmission in the primary device, other associated software components may also be used, wherein these other associated software components may be used in conjunction with the system [100] and the system [200].

According to the disclosure, it is to be acknowledged that the functionality described for the various components/units can be implemented interchangeably. While various embodiments may disclose a particular functionality of these units for clarity, it is recognized that various configurations and combinations thereof are within the scope of the disclosure. The functionality of specific units as disclosed in the disclosure should not be construed as limiting the scope of the present disclosure. Consequently, alternative arrangements and substitutions of units, provided they achieve the intended functionality described herein, are considered to be encompassed within the scope of the present disclosure.

The trusted device determination module [202] may detect nearby devices through a short-range wireless network by analysing a received signal strength indicator (RSSI) values associated with the nearby devices. The trusted device determination module [202] may filter the detected nearby devices to determine one or more trusted devices based on one or more essential criteria such as they are currently in an inactive state and support a small data transmission over CG resources. By doing so, the trusted device determination module [202] ensures that only suitable devices are considered for uplink data transmission of the primary device thereby enhancing the overall efficiency and reliability of the small data transmission over the CG resources of the detected nearby devices.

The device selection module [204] may leverage an artificial intelligence (AI) engine to intelligently select trusted devices from the one or more determined trusted devices for the small data transmission. The device selection module [204] by analysing one or more network parameters such as a signal power, a CG periodicity, and a signal-to-noise ratio (SNR) may determine a suitability of the small data transmission from each of the trusted device from the selected trusted devices. Further, the device selection module [204] may utilise the AI engine for analysing the one or more network parameters to determine the suitability of the small data transmission. This analysis enables the device selection module [204] to prioritize devices with most favourable conditions to ensure reliable and efficient data transmission.

The data arrival detection module [206] may be configured to continuously monitor the primary device for an arrival of an uplink data for the small data transmission. Further, the data arrival detection module [206] may also be configured to determine a suitability of the uplink data for the small data transmission over the CG resources of the selected trusted devices.

The configured grant (CG) determination module [208] is configured to determine a probability of successful data transmission on upcoming configured grant resources for all the selected trusted devices. The configured grant (CG) determination module [208] by analysing the characteristics of each trusted device from the selected trusted devices and the CG resources of the selected trusted devices predicts the likelihood of a successful data transmission for the small data transmission over the CG resources of the selected trusted devices.

The resource handler module [210] is configured to manage an allocation of the configured grant (CG) resources of the selected trusted devices to the primary device. Upon receiving the determined probability assessments from the CG determination module [208], the resource handler module [210] reserves the CG resources of the trusted device with the highest probability of the successful data transmission so as to maximize and/or increase the chances of the successful data transmission.

The modem instructor [212] is configured to transfer the uplink data on the configured grant resources of the trusted device reserved by the resource handler module [210]. Upon receiving an information of the reserved CG resources, the modem instructor [212] issues instructions to transmit the uplink data on the reserved CG resources.

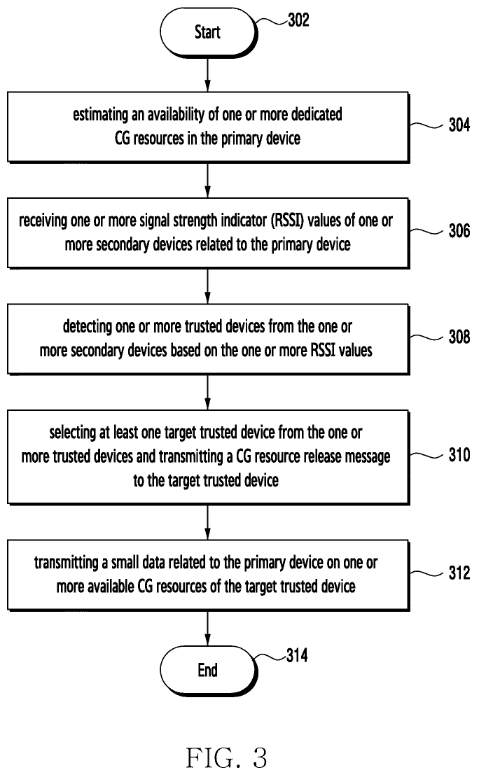

FIG. 3 is a flowchart illustrating an example method [300] for managing a set of dedicated configured grant (CG) resources for small data transmission in a primary device, according to various embodiments. In an implementation the method [300] is performed by a system [100]. In an implementation the method [300] is performed by a system [200]. In an implementation, the method [300] is performed by the system [100] in conjunction with the system [200], wherein at least one of the system [100] and the system [200] may be present in a user equipment (UE) to implement the features of the present disclosure. The method [300] as depicted in FIG. 3 starts at step [302].

At step [304], the method [300] comprises estimating an availability of one or more dedicated CG resources in the primary device.

As used herein, the “dedicated configured grant (CG) resources” may refer to uplink radio resources allocated to the user equipment (UE) in a periodic manner based on estimated traffic requirements. For a small data transmission (SDT) associated with the UE the dedicated CG resources e.g., the dedicated radio resources for uplink transmission are allocated in order to eliminate a potential collision of an uplink message with uplink messages of other Internet of Things (IoT) devices.

As used herein, the “small data transmission (SDT)” may refer to a transfer of small amounts of data, typically less than 100 bytes, over a particular network. The SDT may be designed for applications that require minimal data exchange, such as sensor data, periodic updates, or control signals. In an implementation, the SDT data is transmitted in short bursts by utilizing one or more protocols that prioritize efficiency and low latency over high-speed data transfer to conserve network resources, reduces power consumption, and enables reliable communication for devices that only need to send or receive small amounts of data infrequently.

The availability of the one or more dedicated CG resources in the primary device is estimated based on an uplink data transmission periodicity parameter of the one or more dedicated CG resources in the primary device.

As used herein, the “uplink data transmission periodicity parameter of the one or more dedicated CG resources in the primary device” may refer to a frequency of allocating the one or more dedicated CG resources to the primary device within a particular time period.

At step [306], the method [300] comprises receiving one or more signal strength indicator (RSSI) values of one or more secondary devices related to the primary device.

As used herein, the “one or more signal strength indicator (RSSI) values” may refer to a measure of a power level of a received radio signal at a receiver from one or more transmitters. The RSSI values represent a strength of a signal detected by the receiver from the one or more transmitters, typically measured in decibels (dB) or decibels relative to a milliwatt (dBm). A higher RSSI value indicates a stronger signal, while a lower value indicates a weaker signal. The RSSI values are usually represented on a scale of 0 to −100 dBm, where 0 dBm is the maximum signal strength and −100 dBm is the minimum detectable signal.

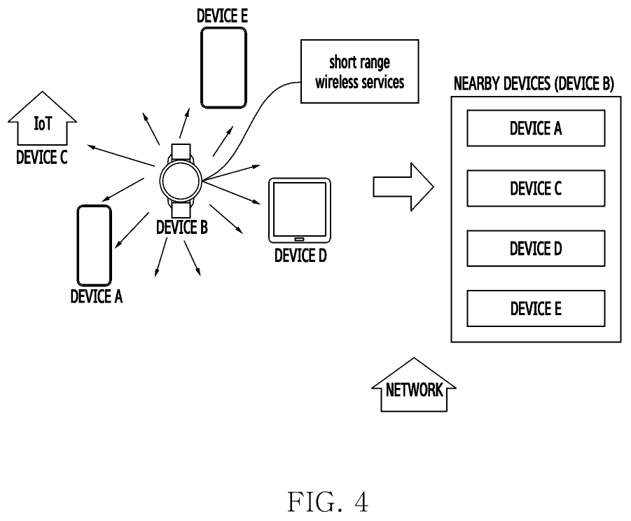

For ease of understanding, let us consider an example arrangement of devices as illustrated in FIG. 4 wherein a primary device e.g., a Device B receives signal strength indicator (RSSI) values of a Device A, a Device C, a Device D and a Device E e.g., the one or more secondary devices. In an implementation of the present disclosure as disclosed herein the one or more signal strength indicator (RSSI) values of the one or more secondary devices may be received by the primary device in an event the one or more secondary devices are within a predefined range of the primary device (e.g., nearby device), wherein the primary device may utilize short range wireless services to detect the one or more secondary devices that are within the predefined range of the primary device. As used herein, the short range wireless services may refer to a wireless communication methodology that operate over a short distance, typically within a range of a few meters or feet to enable a device e.g., the primary device, to connect and exchange data with other devices e.g., the one or more secondary devices, within said short distance and/or with a central hub associated with the primary device and the one or more secondary devices.

Referring back to FIG. 3, at step [308], the method [300] comprises detecting one or more trusted devices from the one or more secondary devices based on the one or more RSSI values.

In an implementation of the present disclosure, in order to detect the one or more trusted devices from the one or more secondary devices, the method [300] may comprise comparing the one or more RSSI values with a predefined threshold RSSI value, wherein the predefined threshold RSSI value is related to an event when the primary device and the one or more trusted devices are in a range of a wireless network.

As used herein, the “predefined threshold RSSI value” may refer to a specific (e.g., specified) signal strength level that may be required to trigger an event or action when the primary device and the one or more trusted devices are within range of the wireless network. In an implementation, the predefined threshold RSSI value may be set to define the minimum signal strength required for reliable communication between the primary device and the one or more trusted devices. Furthermore, the predefined threshold RSSI value may be a value predetermined based on factors such as a network type, transmission capabilities of the primary device and the one or more trusted devices, and application requirements so as to ensure that the primary device and the one or more trusted devices maintain a stable connection within the wireless network.

To detect the one or more trusted devices from the one or more secondary devices, the method [300] may comprise comparing an identifier of the primary device with one or more identifiers of the one or more secondary devices.

As used herein, the “identifier of the primary device” may refer to a unique label or a code such as an account name, a username and any other such like label, that distinguishes the primary device from the one or more secondary devices within the wireless network.

In an implementation of the present disclosure, the one or more secondary devices are detected as the one or more trusted devices in an event the one or more RSSI values is above the predefined threshold RSSI value, and a value of the one or more identifiers of the one or more secondary devices matches to a value of the identifier of the primary device.

For ease of understanding, continuing from the above example (referring again to FIG. 4), wherein a primary device e.g., the Device B receives signal strength indicator (RSSI) values of the Device A, the Device C, the Device D and the Device E e.g., the one or more secondary devices. Further, the received signal strength indicator (RSSI) values of the Device A, the Device C, the Device D, and the Device E by the Device B, wherein the Device B associated with the identifier such as an account name “XYZ” are as depicted below in table 1. Further, the predefined threshold RSSI value is 100 unit.

TABLE 1

| S. No | Device | RSSI Value | Identifier |
|---|---|---|---|
| 1 | Device A | 110 unit | XYZ |
| 2 | Device C | 120 unit | XYZ |
| 3 | Device D | 135 unit | MNP |
| 4 | Device E | 105 unit | XYZ |

According to the present disclosure, the Device A, the Device C and the Device E may be detected as the one or more trusted devices from the one or more secondary devices e.g., the Device A, the Device C, the Device D and the Device E based on the comparing the identifier of the Device B (the primary device) e.g., the account name “XYZ” with one or more identifiers of the Device A, the Device C, the Device D and the Device E as depicted in table 1 above.

The received signal strength indicator (RSSI) values and the predefined threshold RSSI value as disclosed above are examples and should not be construed as limiting the scope of the present disclosure. Further, one skilled in the art will recognize that the disclosed values are for illustrative purposes and may need to be adjusted or modified for practical applications of the present disclosure.

At step [310], the method [300] comprises selecting at least one target trusted device from the one or more trusted devices and transmitting a CG resource release message to the target trusted device.

According to the present disclosure, the target trusted device from the one or more trusted devices is selected based on at least one of an availability of one or more CG resources of the one or more trusted devices, an uplink data transmission periodicity of the one or more CG resources, a signal to noise (SNR) ratio of the one or more trusted devices, a signal power of the one or more trusted devices, and a transmission probability of another small data at set of the trusted device CG resources.

As used herein, the “CG resource release message” may refer to a signal transmitted to release resources allocated to the target trusted device and/or for a specific data transmission session. Once the CG resource release message is transmitted to the target trusted device, one or more network resources, e.g., the CG resources, of the target trusted device are reallocated to the primary device to reduce congestion and/or optimize data transmission associated with the primary device. The CG resource release message triggers the target trusted device to release its allocated resources, such as bearer contexts, radio resources and any other such like resources, allowing the wireless network to reclaim and reuse them for other devices such as the primary device and/or services such as small data transmission service.

As used herein, the “uplink data transmission periodicity of the one or more CG resources” may refer to a regular interval at which the one or more dedicated CG resources are allocated to a particular device. This uplink data transmission periodicity defines how often (in terms of time) the one or more dedicated CG resources are allocated to the particular device over which said particular device may send a data to the wireless network, and the uplink data transmission periodicity may be utilized to ensure that said data is transmitted to the wireless network in an efficient manner.

As used herein, the “signal to noise (SNR) ratio of the one or more trusted devices” may refer to a measure of a ratio of a signal power to a noise power received by the one or more trusted devices. A higher SNR indicates a stronger signal and better communication quality at the one or more trusted devices, while a lower SNR indicates a weaker signal quality at the one or more trusted devices that may result in errors or dropped signal connections.

As used herein, the “signal power of the one or more trusted devices” may refer to a strength of a signal received by the one or more trusted devices. The signal power may be measured in decibels (dB) or decibels relative to a milliwatt (dBm) and is directly proportional to a reliability and a distance between a particular device and a base station of the wireless network.

As used herein, the “transmission probability of another small data” may indicate a likelihood of transmitting another small data by the one or more trusted devices at the set of the trusted device CG resources. The transmission probability may be used to manage resource allocation, prioritize data transmission, and optimize network performance so as to ensure that small data is transmitted from the primary device at the one or more CG resources from the set of the trusted device CG resources.

In an implementation, the present disclosure may utilize an artificial intelligence (AI) technique to select the at least one target trusted device from the one or more trusted devices. In an implementation, the example AI technique to select the at least one target trusted device from the one or more trusted devices (detected above at step [308]) may utilise a neural network-based model, wherein the selection is based on at least three key factors, e.g., the uplink data transmission periodicity of the one or more CG resources, the signal power of the one or more trusted devices, and the signal to noise (SNR) ratio of the one or more trusted devices. Further, each of the three factors may be further categorized into three levels (low, mid, and high) that are provided as an input to the neural network-based model. A vector based on combining the uplink data transmission periodicity of the one or more CG resources, the signal power of the one or more trusted devices, and the signal to noise (SNR) ratio of the one or more trusted devices may be generated. The vector may be fed to the neural network-based model, which may output a binary classification into three classes: good, average, and poor. The output generated by the neural network-based model may be in the form of a 2-dimensional vector representing the probabilities of each class, so as to allow a selection of the target trusted device. In an example scenario, the neural network-based model may utilize a reinforced learning technique to identify a weight associated with each factor from the three factors based on their importance in order to select the at least one target trusted device.

At step [312], the method [300] comprises transmitting a small data related to the primary device on one or more available CG resources of the target trusted device.

In an implementation, in a scenario a location change event is detected by a location tracking manager of the primary device, the solution of the present disclosure in such scenario may identify the one or more available CG resources and one or more network parameters such as the signal power and the signal to noise (SNR) ratio of the selected trusted device so as to trigger an action to update the determined the one or more trusted devices to ensure that only devices with required network parameters and one or more available CG resources are considered. For example, the Device B requests information about available CG resources from the one or more trusted devices and at the same time continuously monitors location changes of the one or more trusted devices, and in an event if a change is detected, a list of the one or more trusted devices is updated based on the monitored location change.

In an implementation of the present disclosure, the method [300] may comprise determining a data transmission probability of the small data on the one or more CG resources based on at least one of the availability of the one or more CG resources, the SNR ratio, the uplink data transmission periodicity, and the signal power.

In an implementation, to determine the data transmission probability of the small data on the one or more CG resources, a neural network based model may be utilised. In an example neural network based model the availability of the one or more CG resources, the SNR ratio, the uplink data transmission periodicity, and the signal power are passed through a neural network engine, including at least one hidden layer. The hidden layer may perform complex computations may utilise one or more computational techniques that may be appreciated by one skilled in the art on the availability of the one or more CG resources, the SNR ratio, the uplink data transmission periodicity, and the signal power to produce an output in a form of “Yes” or “No”, indicating the likelihood of the data transmission probability of the small data on the one or more CG resources. The neural network based model may encompass a reinforced learning technique to identify a weight associated with the availability of the one or more CG resources, the SNR ratio, the uplink data transmission periodicity, and the signal power based on an importance of each of the availability of the one or more CG resources, the SNR ratio, the uplink data transmission periodicity, and the signal power and their interdependency to determine the data transmission probability of the small data on the one or more CG resources.

In an implementation, to determine the data transmission probability of the small data on the one or more CG resources, an artificial intelligence (AI) technique leveraging loss functions associated with the one or more trusted devices may be utilized. An example AI technique to determine the data transmission probability of the small data on the one or more CG resources may incorporates a loss function to minimize and/or reduce errors in predicting transmission probabilities, wherein the loss function is at least one of a cross entropy loss function, a hinge loss function and any other loss function that may be appreciated by one skilled in the art to implement the present disclosure. Further, the example AI technique to determine the data transmission probability of the small data on the one or more CG resources may utilize the following equation:

$$AI ( {x}_{1} , {x}_{2} , {x}_{3} … {x}_{n} ) = Loss ( y\_true - y\_pred )$$

wherein the loss function, Loss( ) takes two inputs—
   y_true that represents an actual transmission outcomes of the small data, and
   y_pred that represents a predicted probabilities of the small data; and
(x₁, x₂, x₃ . . . xₙ) represents a weight associated with the availability of the one or more CG resources, the SNR ratio, the uplink data transmission periodicity, and the signal power.

The example AI technique may optimize/improve the loss function based on the above equation to reduce the difference between a value of the actual transmission outcomes and a value of the predicted probabilities in order to improve its accuracy in predicting transmission probabilities. The AI technique may generate an output comprising a probability value indicating the data transmission probability of the small data on the one or more CG resources.

As disclosed, the data transmission probability of small data may refer to a likelihood of transmitting the small data over the one or more CG resources based on evaluating at least one of the availability of the CG resources, the SNR ratio, the uplink data transmission periodicity, and the signal power. For instance, if one or more CG resources are available, the SNR is high, the uplink transmission periodicity is frequent, and the signal power is strong, the data transmission probability may be high e.g., indicating a high likelihood of successful transmission of a particular small data. If the one or more CG resources are unavailable, the SNR is low, the uplink transmission periodicity is infrequent, and/or the signal power is weak, the transmission probability decreases, indicating a lower likelihood of successful transmission of the particular small data.

According to the present disclosure, the method may comprise reserving the one or more available CG resources of the target trusted device based on the CG resource release message.

In an implementation of the present disclosure, the one or more available CG resources of the target trusted device are further reserved based on the data transmission probability of the small data.

In an implementation of the present disclosure, in a scenario when multiple devices, such as the Device B and a Device X, request CG resources from a common trusted device e.g., a Device A, at the same time t, the present disclosure identifies the highest data transmission probability for each requesting device. If a collision is possible, the disclosure determines the highest probability value for each device. If the highest probability values are different, the resource is reserved for the device with the highest probability value, and the other device in accordance with the various embodiments of the present disclosure is instructed to request the second-highest probability device. However, if the highest probability values are the same, the resource is reserved for the device group with the lowest probability value based on comparing a second highest probability values for the multiple devices, e.g., the Device B and the Device X, and wherein the other device is instructed to request the second-highest probability device. For instance, if the Device B and Device X have trusted devices with highest probability values of 0.8 and 0.7, respectively, the Device B's request is prioritized, and the Device X is instructed to request the second-highest probability device in order to ensure efficient and collision-free data transmission over the requested CG resources.

In an implementation of the present disclosure, the reserving the one or more available CG resources of the target trusted device may further comprise exchanging the one or more available CG resources with at least the one or more dedicated CG resources in the primary device.

According to the present disclosure, the method may comprise determining a suitability of the small data for an uplink transmission based on a comparison of a volume parameter of the small data for the uplink transmission with a predefined volume parameter threshold for the uplink transmission.

As used herein, the “volume parameter of the small data” may refer to a size and/or an amount of the small data intended for the uplink transmission, typically measured in bytes, kilobytes, or megabytes. Further, the volume parameter represents a quantity of data to be transmitted from the primary device to the wireless network.

As used herein, the “predefined volume parameter threshold” may indicate a maximum allowed volume parameter of the small data for the uplink transmission that may be predefined by the wireless network and/or the primary device. The predefined volume parameter threshold may serve as a reference point to determine the suitability of the small data for the uplink transmission so as to ensure that a value of the volume parameter of the small data in a particular transmission does not exceed a preset value of the wireless network and/or the primary device for the uplink transmission of the small data.

As disclosed herein, by comparing the volume parameter of the small data with the predefined volume parameter threshold, the suitability of the small data for uplink transmission may be determined. For example, if the volume parameter of the small data for the uplink transmission exceeds the predefined volume parameter threshold for the uplink transmission, the small data may be split, delayed, or rejected to prevent and/or reduce network congestion condition and/or a device overload condition so as to ensure an efficient uplink transmission of the small data.

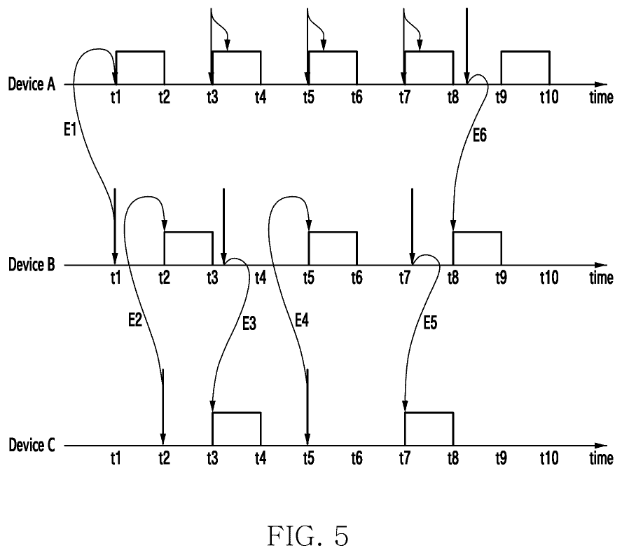

FIG. 5, is a timing diagram illustrating an example flow of small data transmission over dedicated configured grant (CG) resources between one or more devices, according to various embodiments.

As shown in FIG. 5, on occurrence of event 1 (E 1) at time T1 wherein an uplink data is generated for the Device B, and the CG resources of the Device B are not configured at time T1. Then the uplink data for the Device B is transmitted at time T1 on the CG resources of a Device A configured at time T1 in according to various embodiments.

As shown in FIG. 5, on occurrence of event 2 (E 2) at time T2 wherein an uplink data is generated for a Device C, and if the CG resources of the Device C are not configured at time T2, then the uplink data is transmitted at time T2 over the CG resources of the Device B configured at time T2 according to various embodiments.

As shown in FIG. 5, on occurrence of event 3 (E 3) at time T3 an uplink data is generated for the Device B, and the CG resources of the Device B are not configured at time T3. Then the uplink data is transmitted at time T3 for Device B over the CG resources of the Device C configured at time T3 according to various embodiments.

As shown in FIG. 5, on occurrence of event 4 (E 4) at time T5 an uplink data is generated for Device C, wherein the CG resources of the Device C are not configured at T5. The uplink data is transmitted at T5 time for the Device C over the CG resources of the Device B configured at time T5 according to various embodiments.

As shown in FIG. 5, on occurrence of event 5 (E 5) at time T7 an uplink data is generated for the Device B, wherein the CG resources of the Device B are not configured at T7. Then the uplink data is transmitted at time T7 for the Device B over the CG resources of the Device C configured at time T7 according to various embodiments.

As shown in FIG. 5, on occurrence of event 6 (E 6) at time T8 an uplink data is generated for the Device A wherein the CG resources of the Device A are not configured at T8. Then the uplink data is transmitted at time T8 for the Device A over the CG resources of the Device B configured at time T8 according to various embodiments.

Thereafter, the method [300] terminates at step [314].

Various embodiments of the present disclosure may relate to a non-transitory computer-readable storage medium storing instructions for managing a set of dedicated configured grant (CG) resources for small data transmission in a primary device, the instructions include executable code which, when executed by a one or more units of a system [100], causes a processing unit [104] of the system [100] to estimate an availability of one or more dedicated CG resources in the primary device. The executable code when executed causes the processing unit [104] of the system [100] to receive one or more signal strength indicator (RSSI) values of one or more secondary devices related to the primary device. The executable code when executed causes the processing unit [104] of the system [100] to detect one or more trusted devices from the one or more secondary devices based on the one or more RSSI values. The executable code when executed causes the processing unit [104] of the system [100] to select at least one target trusted device from the one or more trusted devices and transmitting a CG resource release message to the target trusted device. The executable code when executed causes the processing unit [104] of the system [100] to transmit a small data related to the primary device on one or more available CG resources of the target trusted device.

As is evident from the above, the present disclosure provides a technically advanced embodiments for managing a set of dedicated configured grant (CG) resources for small data transmission in a primary device. The present disclosure provides technically advanced embodiments that efficiently manage dedicated configured grant (CG) resources for small data transmissions by intelligently selecting trusted devices based on a signal power, a CG periodicity, and a signal-to-noise ratio (SNR) to enhance the reliability and speed of uplink data transmission. The technically advanced embodiments of the present disclosure not only optimizes/improve resource allocation but also ensures that a device connects to the most suitable trusted device, thereby improving overall network performance. Additionally, the technically advanced embodiments of the present disclosure minimize and/or reduce latency and maximize and/or improve data throughput, which is important for applications requiring real-time communication. The technically advanced embodiments of the present disclosure provide several technical effects such as an enhancement of communication efficiency and reliability in data transmission by accurately estimating the availability of CG resources and selecting optimal trusted devices, significantly reduces the chances of transmission failure and improves the quality of service.

According to an embodiment, a method for managing a set of dedicated configured grant (CG) resources for small data transmission in a primary device, may comprise estimating an availability of one or more dedicated CG resources in the primary device, receiving one or more signal strength indicator (RSSI) values of one or more secondary devices related to the primary device, detecting one or more trusted devices from the one or more secondary devices based on the one or more RSSI values, selecting at least one target trusted device from the one or more trusted devices and transmitting a CG resource release message to the target trusted device, and transmitting a small data related to the primary device on one or more available CG resources of the target trusted device.

For example, the method may comprise reserving the one or more available CG resources of the target trusted device based on the CG resource release message. For example, the availability of the one or more dedicated CG resources in the primary device may be estimated based on an uplink data transmission periodicity parameter of the one or more dedicated CG resources in the primary device.

For example, to detect the one or more trusted devices from the one or more secondary devices, the method may comprise comparing the one or more RSSI values with a specified threshold RSSI value, wherein the specified threshold RSSI value is related to an event based on the primary device and the one or more trusted devices being in a range of a wireless network, and comparing an identifier of the primary device with one or more identifiers of the one or more secondary devices. For example, the one or more secondary devices may be detected as the one or more trusted devices based on the one or more RSSI values being above the specified threshold RSSI value, and a value of the one or more identifiers of the one or more secondary devices matching a value of the identifier of the primary device.

For example, the target trusted device from the one or more trusted devices may be selected based on at least one of an availability of one or more CG resources of the one or more trusted devices, an uplink data transmission periodicity of the one or more CG resources, a signal to noise (SNR) ratio of the one or more trusted devices, a signal power of the one or more trusted devices, and a transmission probability of another small data at set of the trusted device CG resources.

For example, the method may comprise determining a data transmission probability of the small data on the one or more CG resources based on at least one of the availability of the one or more CG resources, the SNR ratio, the uplink data transmission periodicity, and the signal power.

For example, the one or more available CG resources of the target trusted device may be further reserved based on the data transmission probability of the small data. For example, the reserving the one or more available CG resources of the target trusted device may comprise exchanging the one or more available CG resources with at least the one or more dedicated CG resources in the primary device. For example, the method may comprise determining a suitability of the small data for an uplink transmission based on a comparison of a volume parameter of the small data for the uplink transmission with a specified volume parameter threshold for the uplink transmission.

According to an embodiment, A system for managing a set of dedicated configured grant (CG) resources for small data transmission in a primary device, may comprise a memory, and at least one processor, comprising processing circuitry, connected at least to the memory, wherein at least one processor, individually and/or collectively, is configured to estimate an availability of one or more dedicated CG resources in the primary device, receive one or more signal strength indicator (RSSI) values of one or more secondary devices related to the primary device, detect one or more trusted devices from the one or more secondary devices based on the one or more RSSI values, select at least one target trusted device from the one or more trusted devices and transmitting a CG resource release message to the target trusted device, and transmit a small data related to the primary device on one or more available CG resources of the target trusted device.

According to an embodiment, A method performed by a first device for managing a set of dedicated configured grant (CG) resources for data transmission, may comprise identifying an availability of one or more dedicated CG resources in the first device, receiving information on one or more signal strength indicator (RSSI) values of one or more second devices related to the first device, identifying one or more trusted devices from among the one or more second devices based on the information on the one or more RSSI values, selecting at least one target device from among the one or more trusted devices and transmitting a CG resource release message to the target device, and transmitting data related to the first device on one or more available CG resources of the target device.

For example, the method may comprise reserving the one or more available CG resources of the target device based on the CG resource release message.

For example, the availability of the one or more dedicated CG resources in the first device may be estimated based on an uplink data transmission periodicity parameter of the one or more dedicated CG resources in the first device.

For example, to detect the one or more trusted devices from the one or more second devices, the method may comprise the one or more RSSI values with a specified threshold RSSI value, wherein the specified threshold RSSI value is related to an event based on the first device and the one or more trusted devices being in a range of a wireless network, and comparing an identifier of the first device with one or more identifiers of the one or more second devices.

For example, the one or more second devices may be detected as the one or more trusted devices based on the one or more RSSI values being above the specified threshold RSSI value, and a value of the one or more identifiers of the one or more second devices matching a value of the identifier of the first device.

For example, the target device from the one or more trusted devices may be selected based on at least one of an availability of one or more CG resources of the one or more trusted devices, an uplink data transmission periodicity of the one or more CG resources, a signal to noise (SNR) ratio of the one or more trusted devices, a signal power of the one or more trusted devices, and a transmission probability of other data at set of the trusted device CG resources.

For example, the method may comprise determining a data transmission probability of the data on the one or more CG resources based on at least one of the availability of the one or more CG resources, the SNR ratio, the uplink data transmission periodicity, and the signal power.

For example, the one or more available CG resources of the target device may be reserved based on the data transmission probability of the data.

For example, the reserving the one or more available CG resources of the target device may comprise exchanging the one or more available CG resources with at least the one or more dedicated CG resources in the first device.

For example, the method may comprise determining a suitability of the data for an uplink transmission based on a comparison of a volume parameter of the data for the uplink transmission with a specified volume parameter threshold for the uplink transmission.

According to an embodiment, a first device for managing a set of dedicated configured grant (CG) resources for small data transmission, may comprise memory comprising one or more storage media, storing instructions, and at least one processor, comprising processing circuitry. The instructions, when executed by at least one processor individually and/or collectively, may cause the first device to identify an availability of one or more dedicated CG resources in the first device, receive information on one or more signal strength indicator (RSSI) values of one or more second devices related to the first device, identify one or more trusted devices from among the one or more second devices based on the information on the one or more RSSI values, select at least one target device from among the one or more trusted devices and transmitting a CG resource release message to the target device, and transmit data related to the first device on one or more available CG resources of the target device.

For example, the instructions, when executed by at least one processor individually and/or collectively, may cause the first device to reserve the one or more available CG resources of the target device based on the CG resource release message.

For example, the availability of the one or more dedicated CG resources in the first device may be estimated based on an uplink data transmission periodicity parameter of the one or more dedicated CG resources in the first device.

For example, the instructions, when executed by at least one processor individually and/or collectively, may cause the first device to compare the one or more RSSI values with a specified threshold RSSI value, wherein the specified threshold RSSI value is related to an event based on the first device and the one or more trusted devices being in a range of a wireless network, and compare an identifier of the first device with one or more identifiers of the one or more second devices.

For example, the one or more second devices may be detected as the one or more trusted devices based on the one or more RSSI values being above the specified threshold RSSI value, and a value of the one or more identifiers of the one or more second devices matching a value of the identifier of the first device.

For example, the target device from the one or more trusted devices may be selected based on at least one of an availability of one or more CG resources of the one or more trusted devices, an uplink data transmission periodicity of the one or more CG resources, a signal to noise (SNR) ratio of the one or more trusted devices, a signal power of the one or more trusted devices, and a transmission probability of other data at set of the trusted device CG resources.

For example, the instructions, when executed by at least one processor individually and/or collectively, may cause the first device to determine a data transmission probability of the data on the one or more CG resources based on at least one of the availability of the one or more CG resources, the SNR ratio, the uplink data transmission periodicity, and the signal power.

For example, the one or more available CG resources of the target device may be reserved based on the data transmission probability of the data.

For example, the instructions, when executed by at least one processor individually and/or collectively, may cause the first device to determine a suitability of the data for an uplink transmission based on a comparison of a volume parameter of the data for the uplink transmission with a specified volume parameter threshold for the uplink transmission.

According to an embodiment, A non-transitory computer readable storage media may store one or more programs. The one or more programs may include instructions which, when executed by at least one processor of a first device, may cause the first device to identify an availability of one or more dedicated CG resources in the first device, receive information on one or more signal strength indicator (RSSI) values of one or more second devices related to the first device, identify one or more trusted devices from among the one or more second devices based on the information on the one or more RSSI values, select at least one target device from among the one or more trusted devices and transmitting a CG resource release message to the target device, and transmit data related to the first device on one or more available CG resources of the target device.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

For one or more embodiments, at least one of the components set forth in one or more of the preceding figures may be configured to perform one or more operations, techniques, processes, and/or methods as set forth herein. For example, a processor (e.g., baseband processor) as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The methods according to various embodiments described in the claims and/or the specification of the disclosure may be implemented in hardware, software, or a combination of hardware and software.

When implemented by software, a computer-readable storage medium storing one or more programs (software modules) may be provided. One or more programs stored in such a computer-readable storage medium (e.g., non-transitory storage medium) are configured for execution by one or more processors in an electronic device. The one or more programs include instructions that cause the electronic device to execute the methods according to embodiments described in the claims or specification of the disclosure.

Such a program (e.g., software module, software) may be stored in a random-access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs), other types of optical storage devices, or magnetic cassettes. Alternatively, it may be stored in a memory configured with a combination of some or all of the above. In addition, respective constituent memories may be provided in a multiple number.

Further, the program may be stored in an attachable storage device that can be accessed via a communication network, such as e.g., Internet, Intranet, local area network (LAN), wide area network (WAN), or storage area network (SAN), or a communication network configured with a combination thereof. Such a storage device may access an apparatus performing an embodiment of the disclosure through an external port. Further, a separate storage device on the communication network may be accessed to an apparatus performing an embodiment of the disclosure.

In the above-described specific embodiments of the disclosure, a component included therein may be expressed in a singular or plural form according to a proposed specific embodiment. However, such a singular or plural expression may be selected appropriately for the presented context for the convenience of description, and the disclosure is not limited to the singular form or the plural elements. Therefore, either an element expressed in the plural form may be formed of a singular element, or an element expressed in the singular form may be formed of plural elements.

Meanwhile, specific embodiments have been described in the detailed description of the disclosure, but it goes without saying that various modifications are possible without departing from the scope of the disclosure.

What is claimed is:

1. A method performed by a first device for managing a set of dedicated configured grant (CG) resources for data transmission, the method comprising:
identifying an availability of one or more dedicated CG resources in the first device;
receiving information on one or more signal strength indicator (RSSI) values of one or more second devices related to the first device;
identifying one or more trusted devices from among the one or more second devices based on the information on the one or more RSSI values;
selecting at least one target device from among the one or more trusted devices and transmitting a CG resource release message to the target device; and
transmitting data related to the first device on one or more available CG resources of the target device.

2. The method as claimed in claim 1, comprising reserving the one or more available CG resources of the target device based on the CG resource release message.

3. The method as claimed in claim 1, wherein the availability of the one or more dedicated CG resources in the first device is estimated based on an uplink data transmission periodicity parameter of the one or more dedicated CG resources in the first device.

4. The method as claimed in claim 1, wherein to detect the one or more trusted devices from the one or more second devices, the method comprises:
comparing the one or more RSSI values with a specified threshold RSSI value, wherein the specified threshold RSSI value is related to an event based on the first device and the one or more trusted devices being in a range of a wireless network, and
comparing an identifier of the first device with one or more identifiers of the one or more second devices.

5. The method as claimed in claim 4, wherein the one or more second devices are detected as the one or more trusted devices based on:
the one or more RSSI values being above the specified threshold RSSI value, and
a value of the one or more identifiers of the one or more second devices matching a value of the identifier of the first device.

6. The method as claimed in claim 1, wherein the target device from the one or more trusted devices is selected based on at least one of an availability of one or more CG resources of the one or more trusted devices, an uplink data transmission periodicity of the one or more CG resources, a signal to noise (SNR) ratio of the one or more trusted devices, a signal power of the one or more trusted devices, and a transmission probability of other data at set of the trusted device CG resources.

7. The method as claimed in claim 6, further comprising determining a data transmission probability of the data on the one or more CG resources based on at least one of the availability of the one or more CG resources, the SNR ratio, the uplink data transmission periodicity, and the signal power.

8. The method as claimed in claim 7, wherein the one or more available CG resources of the target device are further reserved based on the data transmission probability of the data.

9. The method as claimed in claim 1, wherein the reserving the one or more available CG resources of the target device further comprises exchanging the one or more available CG resources with at least the one or more dedicated CG resources in the first device.

10. The method as claimed in 1, further comprising determining a suitability of the data for an uplink transmission based on a comparison of a volume parameter of the data for the uplink transmission with a specified volume parameter threshold for the uplink transmission.

11. A first device for managing a set of dedicated configured grant (CG) resources for data transmission, the first device comprising:
memory comprising one or more storage media, storing instructions; and
at least one processor, comprising processing circuitry,
wherein the instructions, when executed by at least one processor individually and/or collectively, cause the first device to:
identify an availability of one or more dedicated CG resources in the first device;
receive information on one or more signal strength indicator (RSSI) values of one or more second devices related to the first device;
identify one or more trusted devices from among the one or more second devices based on the information on the one or more RSSI values;
select at least one target device from among the one or more trusted devices and transmitting a CG resource release message to the target device; and
transmit data related to the first device on one or more available CG resources of the target device.

12. The first device of claim 11, wherein the instructions, when executed by at least one processor individually and/or collectively, cause the first device to:
reserve the one or more available CG resources of the target device based on the CG resource release message.

13. The first device of claim 11, wherein the availability of the one or more dedicated CG resources in the first device is estimated based on an uplink data transmission periodicity parameter of the one or more dedicated CG resources in the first device.

14. The first device of claim 11, wherein the instructions, when executed by at least one processor individually and/or collectively, cause the first device to:
compare the one or more RSSI values with a specified threshold RSSI value, wherein the specified threshold RSSI value is related to an event based on the first device and the one or more trusted devices being in a range of a wireless network, and
compare an identifier of the first device with one or more identifiers of the one or more second devices.

15. The first device of claim 14, wherein the one or more second devices are detected as the one or more trusted devices based on:
the one or more RSSI values being above the specified threshold RSSI value, and
a value of the one or more identifiers of the one or more second devices matching a value of the identifier of the first device.

16. The first device of claim 11, wherein the target device from the one or more trusted devices is selected based on at least one of an availability of one or more CG resources of the one or more trusted devices, an uplink data transmission periodicity of the one or more CG resources, a signal to noise (SNR) ratio of the one or more trusted devices, a signal power of the one or more trusted devices, and a transmission probability of other data at set of the trusted device CG resources.

17. The first device of claim 16, wherein the instructions, when executed by at least one processor individually and/or collectively, cause the first device to:
determine a data transmission probability of the data on the one or more CG resources based on at least one of the availability of the one or more CG resources, the SNR ratio, the uplink data transmission periodicity, and the signal power.

18. The first device of claim 17, wherein the one or more available CG resources of the target device are further reserved based on the data transmission probability of the data.

19. The first device of claim 11, wherein the instructions, when executed by at least one processor individually and/or collectively, cause the first device to:
determine a suitability of the data for an uplink transmission based on a comparison of a volume parameter of the data for the uplink transmission with a specified volume parameter threshold for the uplink transmission.

20. A non-transitory computer readable storage media storing one or more programs, wherein the one or more programs include instructions which, when executed by at least one processor of a first device, cause the first device to:
identify an availability of one or more dedicated CG resources in the first device;
receive information on one or more signal strength indicator (RSSI) values of one or more second devices related to the first device;
identify one or more trusted devices from among the one or more second devices based on the information on the one or more RSSI values;
select at least one target device from among the one or more trusted devices and transmitting a CG resource release message to the target device; and
transmit data related to the first device on one or more available CG resources of the target device.
